(19) United States
(12) Patent Application Publication
(10) Pub. No.: US 2004/0106372 A1
(43) Pub. Date: Jun. 3, 2004

(54) SYSTEM AND METHOD FOR OPTIMIZING THE EFFICIENCY OF BASE-TO-VEHICLE COMMUNICATION

(75) Inventors: Mats Andersson, Frillesas (SE); Magnus Hultin, Onsala (SE)

Correspondence Address: HOWREY SIMON ARNOLD & WHITE LLP, 1299 PENNSYLVANIA AVE., NW, BOX 34, WASHINGTON, DC, 20004, US

(73) Assignee: VOLVO TECHNOLOGY CORPORATION, Goteborg (SE)

(21) Appl. No.: 10/604,868

(22) Filed: Aug. 22, 2003

Related U.S. Application Data
(63) Continuation of application No. PCT/SE02/00320, filed on Feb. 22, 2002.
(60) Provisional application No. 60/270,640, filed on Feb. 23, 2001.

(51) Int. Cl. H04H 1/00

(52) U.S. Cl. 455/3.02

(57) ABSTRACT

System and method for optimizing the efficiency of base-to-vehicle communication. The method includes beginning a call initiation step for establishing a wireless communication between a base station and a remotely located vehicle. Conditions are sensed at which a prospective wireless communication would be conducted. The sensed conditions are analyzed to determine whether predetermined criteria are met for initiation of the prospective wireless communication. It is then chosen to initiate a wireless communication when the predetermined criteria for initiation of the prospective wireless communication is satisfied based on the analysis of sensed conditions. It may be required that from the sensed conditions it be determined that the remotely located vehicle is traveling below a predetermined threshold speed. Alternatively, the determining condition may be transmission quality for the prospective wireless communication. Based on these and other suitable criteria, variable amounts of electronic data may be sent from the remotely located vehicle to the base station. In another instance, it may be required that from the sensed conditions it be determined that the calculated cost of the prospective wireless communication meets predetermined parameters.

### CROSS REFERENCE TO RELATED APPLICATIONS

The present application is a continuation patent application of International Application No. PCT/SE02/00320 filed Feb. 22, 2002 which was published in English pursuant to Article 21(2) of the Patent Cooperation Treaty, and which claims priority to U.S. Provisional Application No. 60/270,640 filed Feb. 23, 2001. Said applications are expressly incorporated herein by reference in their entireties.

### BACKGROUND OF INVENTION

1. Technical Field

The present invention relates generally to fleet management, and more specifically to the management of costs associated with the transmission of data on wireless communication systems from remotely located vehicles to home-base receivers.

1. Background

It is a common practice in fleet management programs to gather data from remotely located vehicles for tracking purposes and for efficient management of the individual vehicles, as well as for that of the fleet of several vehicles when taken in the aggregate. The communication of data from such vehicles which may include trucks, trains, automobiles, boats, airplanes and other fleet oriented modes of transportation, is typically made over wireless networks such as through the utilization of satellite and/or cellular service. In the instance of cellular service which is commonly utilized by land based vehicles, not only is the quality of data transmission dependent upon the location of the vehicle, but so is the cost. For example, it has been appreciated that both transmission quality and cost are adversely affected when away from metropolitan/urban areas. When in a metropolitan area such as a city-center, the infrastructure for cellular service is typically robust to accommodate the high density of users in that localized area. Furthermore, the cost of cellular service is typically less in these urban areas because the non-variable costs of the system may be spread among a multitude of users.

The cost of transmission may be affected in another way as well based on quality of transmission. When a transmission connection is lost during data transfer, a resend function is typically initiated. In the subsequent resend(s), it is not uncommon for the entire set of data to be transmitted, not just the unsent portions. This can occur repeatedly, especially in poor transmission areas, significantly increasing the cost to achieve a completed data transmission.

Regarding reception, quality is typically higher in city areas because the user is closer to the stationary antenna which receive and transmit the communications. This may be contrasted to highway conditions which are often in rural areas where transmission quality may be poor and costs will be high. This situation can often be attributed to a lack of competition in the rural areas. For instance, it is not economically feasible for a plurality of service providers to establish individual infrastructures along remote highways. Therefore, a single provider will typically be encountered who may operate in an essentially monopolistic manner.

One prevailing characteristic regarding the retrieval of data from such remotely located vehicles is that such retrieval is not typically time critical. That is to say, the data may be retrieved from the vehicle within suitable time frames or windows; and therefore, some leniency is permitted with respect to the exact time that data is required to be down-loaded from the vehicle(s). In this regard, the present invention appreciates that these times for download may be strategically selected, and that the nature of the individual downloads may be strategically customized to minimize cost and potentiate transmission quality.

In view of the above described deficiencies associated with the use of known arrangements and methods for affecting fleet information gathering, the present invention has been developed to alleviate these drawbacks and provide further benefits to the user. These enhancements and benefits are described in greater detail hereinbelow with respect to several alternative embodiments of the present invention.

### SUMMARY OF INVENTION

The present invention in its several disclosed embodiments alleviates the drawbacks described above with respect to conventionally designed fleet information gathering systems and methods, and incorporates several additionally beneficial features.

The present invention, among others, has several important goals: one is to assure quality data transmission from remotely located fleet vehicles to home-base central systems, and another is to minimize associated costs with these transmissions. Another goal of the invention is to enable the user to predict costs associated with fleet data transmission. Because the data transfer conditions can be better controlled, so can the costs associated therewith.

One concept of the invention is that pre-analysis is performed before data transmission is initiated. Since such data transmission is typically over a cellular system when land-based vehicles are considered, certain conditions can be evaluated prior to the commencement of the actual communication data link. For instance, the local provider of the cellular service to the vehicle has a primary bearing on the cost of the transmission. Therefore, one consideration is to determine the identity of the local provider or operator at the time that a data transmission is prescribed. This evaluation is made before an actual transmission is initiated so that a decision can be made whether or not to proceed with initiation, or to hold the transmission until a later point in time. The assessment of the cellular provider may be made on several different basis. For instance, a pre-approved listing of providers may be utilized, or certain cost calculations may be made at the time that a particular transmission is desired.

In another aspect, vehicle speed has been found to be a reasonable predictor of cellular service conditions. Above certain threshold vehicle speeds, it can be assumed that the vehicle is traveling on highways and likely to be outside of urban areas. There are other suitable vehicle characteristics, that is, other than speed, that may be sensed for evaluating the location of the vehicle as to whether it is in an urban or rural setting. For instance, present gear selection, frequency of gear changing, and cruise control status (engaged versus disengaged) are examples of such predictive vehicle characteristics. Driver characteristics may also be predictive of the driving environment. For example, the sensing and tracking of driver eye movement may be utilized in determining the driving environment; fast movement usually denotes city driving, while more steady direction of the eyes typically denotes highway driving. Actual environmental characteristics may also be evaluated. In this regard, lane tracking and other road-related sensing systems may be employed in the determination process to assess current driving environment.

As described hereinabove, more rural locales will typically not be preferred for a data transmission and resultingly can be avoided. In this instance, the timing of a download of data from the vehicle to the central system may either be delayed, or the data content (packet) may be abbreviated to presently supply only critical or otherwise prescribed data, while postponing a full data download until later when more advantageous transmission conditions are identified.

In yet another aspect, the available quality of transmission for data may be analyzed in the determination of whether or not to initiate a data download. If transmission quality is significantly low, the download can be postponed until conditions improve. In this regard, reception conditions may be monitored for a period of time to ascertain signal consistency, which may also be an important parameter utilized in the decision process in determining whether or not to initiate a data transfer.

Not only can these and similar criteria be utilized for determining whether or not to initiate a data transmission, but they can also be used to determine whether or not a data transmission that is in progress should be allowed to continue, or be interrupted. For instance, if a vehicle travels out of the cellular area of an approved provider into the area of an unapproved provider, the transmission may be immediately terminated, or truncated, and later completed under more acceptable conditions.

The beneficial effects described above apply generally to the exemplary systems, methods and schemes that are disclosed herein for a fleet management system; and more specifically, to the initiation and retrieval of information from remotely located vehicles that assure quality of transmission and permit the management of associated costs. The specific arrangements and procedures through which these benefits are delivered will be described in detail hereinbelow.

### BRIEF DESCRIPTION OF DRAWINGS

The invention will now be described in greater detail in the following way of example only and with reference to the attached drawings, in which:

FIG. 1 is a schematic representation of an information gathering and management system for vehicle fleets.

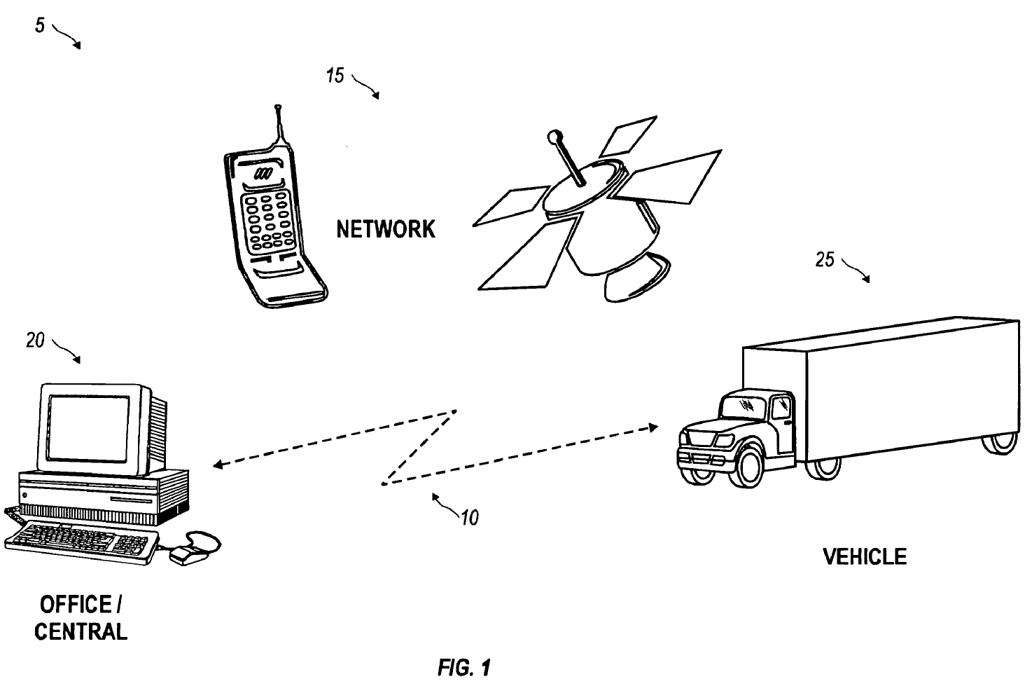

FIG. 2 is flow chart representing steps in the initiation process of a data reporting transmission.

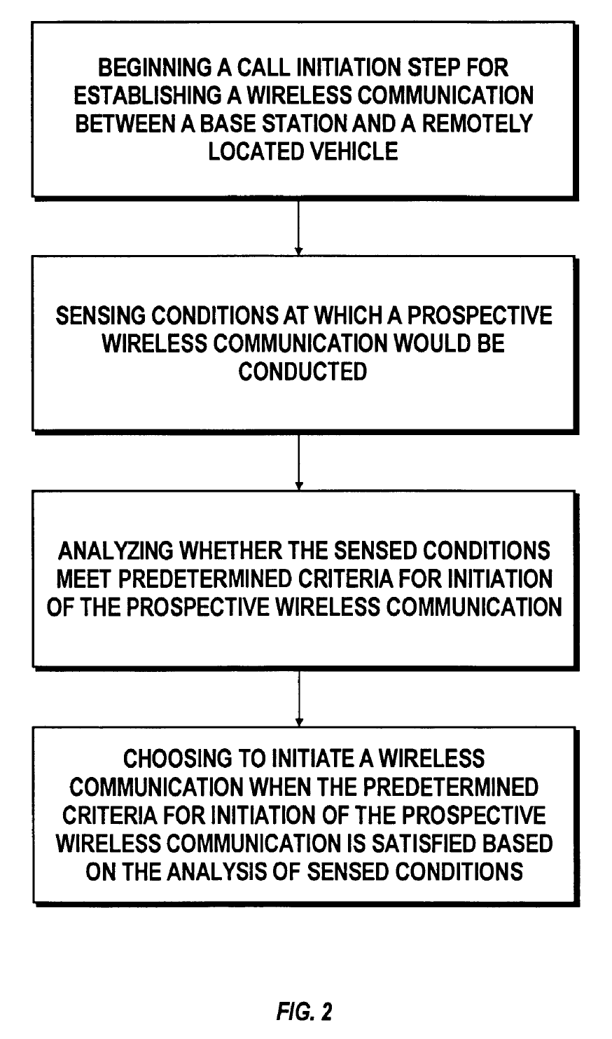

FIG. 3 is flow chart representing steps in a decision to abort the initiation process of a data reporting transmission.

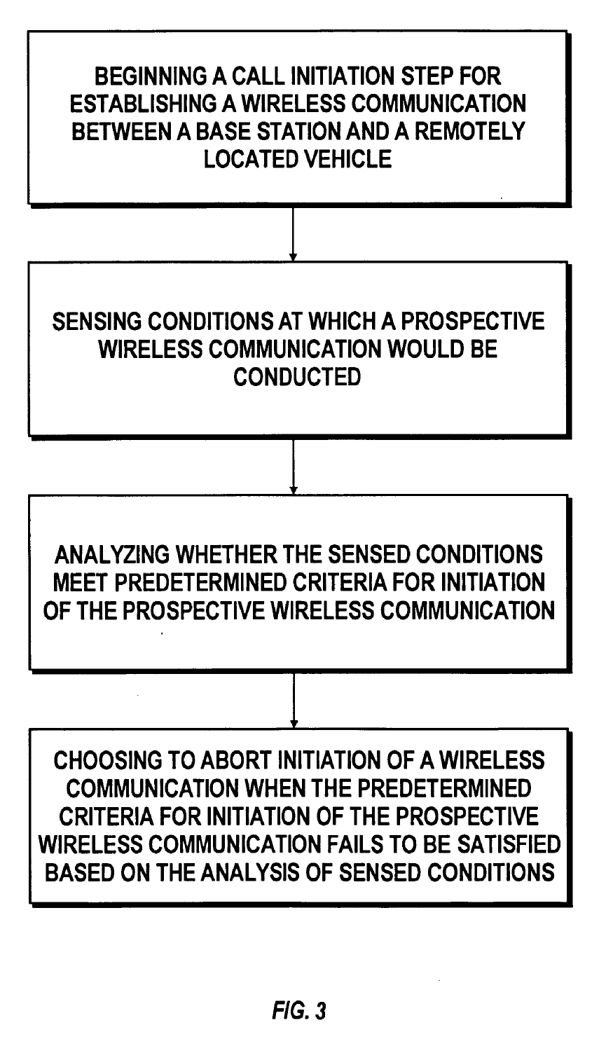

### DETAILED DESCRIPTION

As required, detailed embodiments of the present invention are disclosed herein; however, it is to be understood that the disclosed embodiments are merely exemplary of the invention that may be embodied in various and alternative forms. The figures are not necessarily to scale, some features may be exaggerated or minimized to show details of particular components. Therefore, specific structural and functional details disclosed herein are not to be interpreted as limiting, but merely as a basis for the claims and as a representative basis for teaching one skilled in the art to variously employ the present invention.

Referring to the Figures, in at least one embodiment, the present invention takes the form of a system 5 for optimizing the efficiency of base-to-vehicle communication 10. In a related aspect, the invention takes the form of a method for optimizing the efficiency of base-to-vehicle communication 10. The method includes beginning a call initiation step for establishing a wireless communication 10 between a base station 20 and a remotely located vehicle 25. Conditions are sensed at which a prospective wireless communication 10 would be conducted. The sensed conditions are analyzed to determine whether predetermined criteria are met for initiation of the prospective wireless communication 10. It is then chosen to initiate a wireless communication 10 when the predetermined criteria for initiation of the prospective wireless communication 10 is satisfied based on the analysis of sensed conditions.

In one instance, it may be required that from the sensed conditions it be determined whether the remotely located vehicle 25 is traveling below a predetermined threshold speed. For example, such a threshold speed that would be indicative of highway travel versus urban travel. Alternatively, the determining condition may be transmission quality for the prospective wireless communication 10. Based on these and other suitable criteria, variable amounts of electronic data may be sent from the remotely located vehicle 25 to the base station 20. Exemplarily, abbreviate amounts of electronic data may be sent from the remotely located vehicle 25 to the base station 20 when conditions are acceptable, but not optimal. Alternatively, complete electronic data may be sent from the remotely located vehicle 25 to the base station 20 when conditions are optimal, or at least in an acceptable range.

In another instance, it may be required that from the sensed conditions it be determined whether the calculated cost of the prospective wireless communication 10 meets predetermined parameters. Depending on this calculated cost, a similar scheme may be utilized for sending variable amounts of data from the vehicle 25 to the base 20 considering the cost of sending that information.

In another aspect, it may be decided to abort initiation of the prospective wireless communication 10 when the predetermined criteria for initiation of the prospective wireless communication 10 fail to be satisfied based on the analysis of sensed conditions. For instance, the calculated cost of the prospective wireless communication 10 exceeds a threshold amount. Alternatively, a sensed speed of the vehicle 25 may indicate highway travel where reception is more typically of poor quality and related transmission costs are high.

In an alternative respect, the decision as to whether or not to initiate a wireless communication 10 may be based on the identity of the local provider (or network operator) 15 of wireless communication services to the remotely located vehicle 25. If the local provider 15 is an approved provider, then the transmission 10 may be initiated. If the local provider 15 is not an approved provider, then initiation may be postponed and/or aborted.

One exemplary implementation of the present invention may assume that the office system or base 20 and a communications unit in the vehicle 25 is using a Swedish Europolitan subscription in a GSM cellular telephone. The vehicle 25 travels from Sweden into Norway, and due to bad Europolitan coverage, the cellular service provider 15, also referred to as the operator 15, is selected to be Telenor due to roaming. While in this area, the home system 20 wants to upload data and connects a GSM data call with the communications unit in the vehicle 25. This connection 10 having been established, the office system 20 can then request information from the vehicle 25 regarding which operator 15 is being used in the vehicle. If it is a non-preferred operator, then the call may be disconnected, or the data transmission reduced to information that is minimally necessary at that moment.

In a similar manner, the transmission process maybe initiated at the vehicle without the requirement of a polling inquiry from the base station 20. Similar parameters may be checked prior to initiation of any cellular transmission thereby avoiding the incurrence of any charges until suitable conditions that meet predetermined criteria are detected.

While wireless communication modes are primarily contemplated regarding the present invention, it is contemplated that suitable substitute modes may be employed in carrying out the identified goals of the invention.

In summary, a system and method for managing fleet communications is described herein. These and other variations, which will be appreciated by those skilled in the art, are within the intended scope of this invention as claimed below. As previously stated, detailed embodiments of the present invention are disclosed herein; however, it is to be understood that the disclosed embodiments are merely exemplary of the invention that may be embodied in various forms.

1. A method for optimizing the efficiency of base-to-vehicle communication, said method comprising the steps of:
beginning a call initiation step for establishing a wireless communication between a base station and a remotely located vehicle;
sensing conditions at which a prospective wireless communication would be conducted;
analyzing whether the sensed conditions meet predetermined criteria for initiation of the prospective wireless communication; and
choosing to initiate a wireless communication when the predetermined criteria for initiation of the prospective wireless communication is satisfied based on the analysis of sensed conditions.

2. The method for optimizing the efficiency of base-to-vehicle communication as recited in claim 1, said method further comprising:
determining from the sensed conditions that the remotely located vehicle is traveling below a predetermined threshold speed.

3. The method for optimizing the efficiency of base-to-vehicle communication as recited in claim 1, said method further comprising:
determining from the sensed conditions that the remotely located vehicle is traveling below a threshold speed indicative of highway travel.

4. The method for optimizing the efficiency of base-to-vehicle communication as recited in claim 1, said method further comprising:
determining from the sensed conditions transmission quality for the prospective wireless communication.

5. The method for optimizing the efficiency of base-to-vehicle communication as recited in claim 4, said method further comprising:
sending variable amounts of electronic data from the remotely located vehicle to the base station based on the determined transmission quality for the prospective wireless communication.

6. The method for optimizing the efficiency of base-to-vehicle communication as recited in claim 4, said method further comprising:
sending abbreviate amounts of electronic data from the remotely located vehicle to the base station based on the determined transmission quality for the prospective wireless communication being above a threshold quality.

7. The method for optimizing the efficiency of base-to-vehicle communication as recited in claim 4, said method further comprising:
sending complete electronic data from the remotely located vehicle to the base station based on the determined transmission quality for the prospective wireless communication being below a threshold quality.

8. The method for optimizing the efficiency of base-to-vehicle communication as recited in claim 1, said method further comprising:
determining from the sensed conditions that the remotely located vehicle is traveling at a speed indicative of urban travel.

9. The method for optimizing the efficiency of base-to-vehicle communication as recited in claim 1, said method further comprising:
determining from the sensed conditions that the remotely located vehicle is traveling in an urban environment.

10. The method for optimizing the efficiency of base-to-vehicle communication as recited in claim 1, said method further comprising:
completing the prospective wireless communication when a calculated cost of the prospective wireless communication meets predetermined parameters.

11. The method for optimizing the efficiency of base-to-vehicle communication as recited in claim 10, said method further comprising:
sending variable amounts of electronic data from the remotely located vehicle to the base station based on the calculated cost of the prospective wireless communication.

12. The method for optimizing the efficiency of base-to-vehicle communication as recited in claim 10, said method further comprising:
sending abbreviate amounts of electronic data from the remotely located vehicle to the base station based on the calculated cost of the prospective wireless communication being above a threshold amount.

13. The method for optimizing the efficiency of base-to-vehicle communication as recited in claim 10, said method further comprising:
sending complete electronic data from the remotely located vehicle to the base station based on the calculated cost of the prospective wireless communication being below a threshold amount.

14. A method for optimizing the efficiency of base-to-vehicle communication, said method comprising the steps of:
beginning an initiation step for establishing a wireless communication between a base station and a remotely located vehicle;
sensing conditions at which a prospective wireless communication would be conducted;
analyzing whether the sensed conditions meet predetermined criteria for initiation of the prospective wireless communication; and
choosing to abort initiation of the prospective wireless communication when the predetermined criteria for initiation of the prospective wireless communication fail to be satisfied based on the analysis of sensed conditions.

15. The method for optimizing the efficiency of base-to-vehicle communication as recited in claim 14, said method further comprising:
aborting initiation of the prospective wireless communication when a calculated cost of the prospective wireless communication exceeds a threshold.

16. The method for optimizing the efficiency of base-to-vehicle communication as recited in claim 14, said method further comprising:
determining from the sensed conditions that the remotely located vehicle is traveling above a threshold speed indicative of highway travel.

17. The method for optimizing the efficiency of base-to-vehicle communication as recited in claim 14, said method further comprising:
determining from the sensed conditions that the remotely located vehicle is traveling in an urban environment.

18. A method for optimizing the efficiency of base-to-vehicle communication, said method comprising the steps of:
beginning a call initiation step for establishing a wireless communication between a base station and a remotely located vehicle;
sensing the identity of the local provider of wireless communication services to the remotely located vehicle;
determining whether that local provider is an approved provider; and
choosing to initiate a wireless communication when the identified provider is approved to provide wireless communications between the base station and the remotely located vehicle.

19. A method for optimizing the efficiency of base-to-vehicle communication, said method comprising the steps of:
beginning a call initiation step for establishing a wireless communication between a base station and a remotely located vehicle;
sensing the identity of the local provider of wireless communication services to the remotely located vehicle;
determining whether that local provider is an approved provider; and
choosing to abort initiation of a wireless communication when the identified provider is not approved to provide wireless communications between the base station and the remotely located vehicle.
